(19) United States
(12) Patent Application Publication
(10) Pub. No.: US 2005/0252178 A1
(43) Pub. Date: Nov. 17, 2005

(54) Dual jet cleaning system for dust filter assembly

(76) Inventor: Kenneth L. Richard, Knoxville, TN (US)

Correspondence Address: James G. O'Boyle, Esq.;711 Chevy Chase Building, 5530 Wisconsin Avenue, Chevy Chase, MD, 20815, US

(21) Appl. No.: 11/125,230

(22) Filed: May 10, 2005

Related U.S. Application Data
(60) Provisional application No. 60/569,643, filed on May 11, 2004.

(51) Int. Cl. B01D 46/04

(52) U.S. Cl. 55/302

(57) ABSTRACT

A dual jet cleaning system for a dust filter assembly having a pair of first and second axially aligned cartridge filters and a compressed air source. A first reduced diameter pipe is connected to the compressed air source and a second further reduced diameter pipe is positioned coaxially within the outlet of the first reduced diameter pipe and secured thereto. An annular passage is formed between the interior wall surface of the first reduced diameter pipe and the exterior wall surface of the second further reduced diameter pipe to provide a first jet for cleaning the first filter, the outlet of the second further reduced diameter pipe extends into the first filter to provide a second jet for cleaning the second filter.

### CROSS-REFERENCE TO RELATED APPLICATION

This application claims the benefit of Provisional Patent Application Ser. No. 60/569,643 filed May 11, 2004.

### BACKGROUND OF THE INVENTION

In dust collectors of the type shown in U.S. Pat. No. 4,395,269, dated Jul. 26, 1983, and in applicant's U.S. Pat. No. 4,610,704, dated Sep. 9, 1986, a plurality of individual filter elements are enclosed in a housing which admits particulate laden gases into the top of the housing to flow downward and radially inwardly of the individual filter elements so that particulates accumulate on the exterior of the filters. The interior of the filter elements communicate with a common clean air duct at the bottom of the housing. In order to periodically clean the filter elements, a compressed air source is arranged to fire pulses of compressed air through a nozzle into the interior of the filter elements to remove the particulates from the exterior surface of the filter element. The location of a pulsed air source with a respective filter element is known as a filter cleaning station. When there is only one filter element per cleaning station, the pulses of compressed air cleans the filter element efficiently; but in collectors where a second filter is installed in alignment with a first filter at a cleaning station, it has been found that the pressure of the compressed air pulse was not sufficient to efficiently clean the second air filter.

After considerable research and experimentation, the dual jet cleaning system of the present invention has been devised wherein the compressed air source pipe can be retrofiltered to a dust collector to thereby provide a dual jet cleaning system, whereby the first and second air filters are efficiently cleaned.

### SUMMARY OF THE INVENTION

The dual jet cleaning system of the present invention comprises, essentially, a first reduced diameter pipe coupled to the end of the existing compressed air source pipe, and a second further reduced diameter pipe positioned coaxially within the outlet of the first reduced diameter pipe and secured thereto, whereby an annular passage is formed between the interior wall surface of the first reduced diameter pipe and the exterior wall surface of the second further reduced diameter pipe to thereby provide a first jet for cleaning the first filter.

The outlet of the second further reduced diameter pipe extends into the first filter to thereby provide a second jet for cleaning the second filter.

### BRIEF DESCRIPTION OF THE DRAWINGS

FIG. 1 is a side elevational view, partly in section, illustrating a prior art dust collector;

FIG. 2 is a side elevational view, partly in section, of a jet cleaning system employed in the dust collector illustrated in FIG. 1;

FIG. 3 is a side elevational view, partly in section, illustrating the dual jet cleaning system of the present invention retrofiltered to the cleaning system shown in FIG. 2;

FIG. 4 is a perspective view of the dual jet cleaning system of the present invention; and,

FIG. 5 is a view taken along line 5-5 of FIG. 4.

### DESCRIPTION OF THE PREFERRED EMBODIMENT

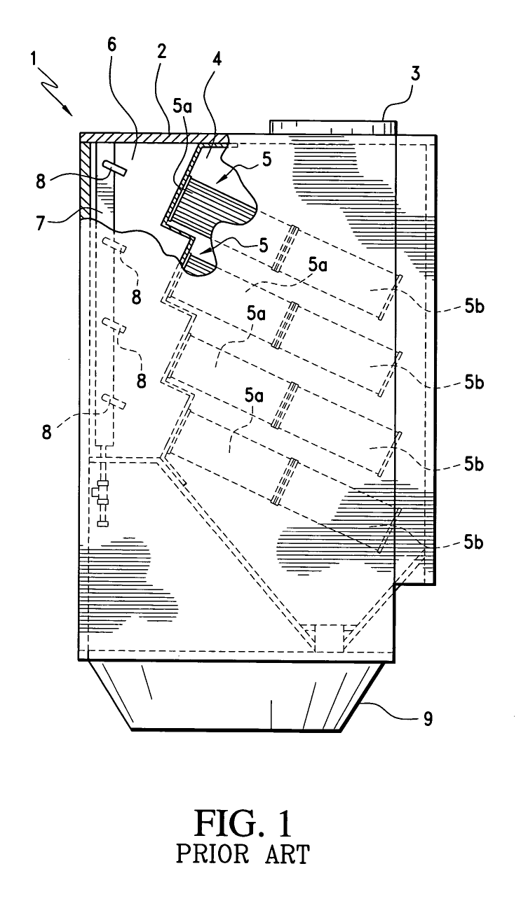

Referring to the drawings, and more particularly to FIG. 1, an industrial air filter assembly 1 of the type disclosed in U.S. Pat. No. 4,395,269 dated Jul. 26, 1983, is illustrated which includes a housing 2 having an air inlet 3 communicating with a dirty air chamber 4 containing a plurality of inclined filter elements 5. Each element comprises a first filter cartridge 5a and a second filter cartridge 5b axially aligned with the first filter cartridge 5a.

Particulate laden gases flow through the inlet 3 into the housing 2 and downwardly and radially inwardly of the filter elements 5 so that particulates accumulate on the exterior of the filter cartridges 5a and 5b. The interior of the filter elements 5 communicates with a common clean air duct 6.

In order to periodically clean the filter elements 5 a compressed air source 7 is arranged to fire pulses of compressed air through a plurality of nozzles 8 into the interior of the filter elements 5 to remove the particulates from the exterior surface of the filter elements 5 which drop into a hopper 9 at the bottom of the housing 2.

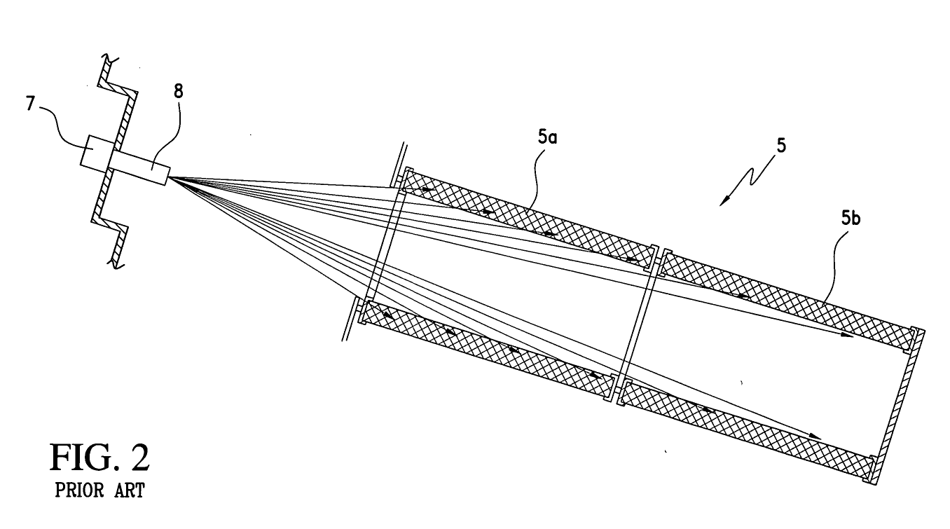

As will be seen in FIG. 2, the location of the compressed air pulses with a respective filter element 5 is known as a filter cleaning station. When there is only one filter cartridge 5a per cleaning station, the pulses of compressed air clean the filter cartridge efficiently; but, as shown in FIG. 2, in collectors where a second filter cartridge 5b is installed in alignment with the first filter cartridge 5a, it has been found that the pressure of the compressed air pulse is not sufficient to efficiently clean the second air filter 5b.

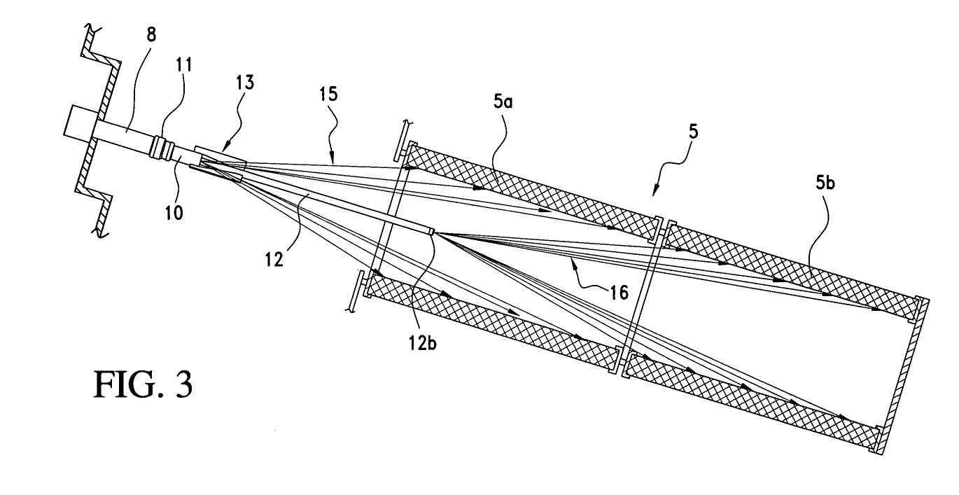

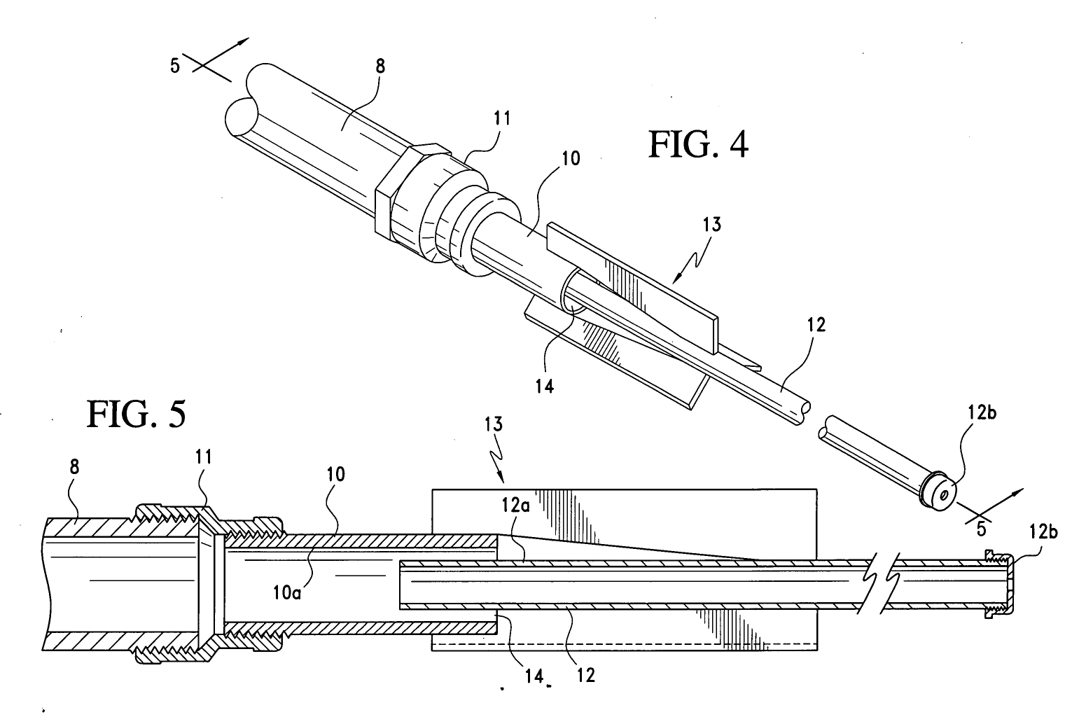

To overcome the cleaning deficiencies experienced in the prior art cleaning system as illustrated in FIGS. 1 and 2, the dual jet cleaning system of the present invention, as shown in FIGS. 3, 4 and 5 can be retrofitted to the nozzle 8 and comprises a first reduced diameter pipe 10 connected to the end of nozzle 8 by a reducer 11, and a second further reduced diameter pipe 12 positioned coaxially within the outlet of the first reduced diameter pipe 10 and fixedly mounted therein by a spider 13 welded to the pipes 10 and 12, whereby an annular passage 14 is formed between the interior wall surface 10a of the first pipe 10 and the outer wall surface 12a of the second pipe 12 to thereby provide a first jet 15 for cleaning the first filter 5a.

The outlet 12b of the pipe 12 extends into the first filter 5a, to thereby provide a second jet 16 for cleaning the second filter 5b.

From the above description, it will be appreciated by those skilled in the art that by sequentially reducing the diameter of the compressed air flow passage from pipe 8 through pipes 10 and 12, the pressure of the compressed air pulses is sequentially increased through the first and second filter cartridge 5a and 5b, whereby both filter cartridges are effectively cleaned.

It is to be understood that the form of the invention herewith shown and described is to be taken as a preferred example of the same, and that various changes in the shape, size and arrangement of parts may be resorted to, without departing from, the spirit of the invention or scope of the subjoined claims.

1. In combination, a dual jet cleaning system and a dust filter assembly having a housing and an air inlet communicating with a dirty air chamber containing a first filter cartridge and a second filter cartridge axially aligned with the first filter cartridge, a compressed air source for firing pulses of compressed air into the interior ot the filter elements for removing particulates from the filter cartridges; the dual jet cleaning system comprising a first reduced diameter pipe connected to a compressed air source, a second further reduced diameter pipe positioned coaxially within the outlet of the first reduced diameter pipe, means for fixedly mounting said second further reduced diameter pipe within the first reduced diameter pipe, to thereby form an annular passage between the interior wall surface of the first reduced diameter pipe and the outer wall surface of the second further reduced diameter pipe, whereby a first jet is provided for cleaning the first filter cartridge, the outlet of the second further reduced diameter pipe extending into the first filter, to thereby provide a second jet for cleaning the second filter, whereby the diameter of the compressed air flow from the compressed air source through the first and second reduced diameter pipes is sequentially reduced, to thereby sequentially increase the pressure of the air pulses through the first and second filter cartridges, whereby both filter cartridges are effectively cleaned.

2. The dual jet cleaning system and diesel filter assembly, according to claim 1, wherein the means for fixedly mounting the second further reduced pipe within the first reduced diameter pipe comprises a spider welded to the pipes.

3. The dual jet cleaning system and duct filter assembly, according to claim 1, wherein the compressed air source includes a nozzle, a reducer connected to said nozzle, the inlet of the first reduced diameter pipe being connected to said reducer.
